(19) United States
(12) Patent Application Publication
(10) Pub. No.: US 2024/0107433 A1
(43) Pub. Date: Mar. 28, 2024

(54) SERVICE BASED ARCHITECTURE FOR NON-ACCESS STRATUM EVOLUTION

(71) Applicant: Apple Inc., Cupertino, CA (US)

(72) Inventors: Sudeep Manithara Vamanan, Nuremberg (DE); Alexander Sirotkin, Tel Aviv (IL); Behrouz Aghili, San Diego, CA (US); Haijing Hu, Los Gatos, CA (US); Krisztian Kiss, Hayward, CA (US); Naveen Kumar R. Palle Venkata, San Diego, CA (US); Peng Cheng, Beijing (CN); Ralf Rossbach, Munich (DE); Vivek G. Gupta, San Jose, CA (US); Yuqin Chen, Beijing (CN); Zhibin Wu, Los Altos, CA (US)

(73) Assignee: Apple Inc., Cupertino, CA (US)

(21) Appl. No.: 18/467,591

(22) Filed: Sep. 14, 2023

Related U.S. Application Data
(60) Provisional application No. 63/409,154, filed on Sep. 22, 2022.

(51) Int. Cl. H04W 48/16; H04W 74/08

(52) U.S. Cl. CPC H04W 48/16; H04W 74/0808

(57) ABSTRACT

The present application relates to apparatus, systems, and methods to provide a service based interface in wireless communication systems.

### CROSS-REFERENCE TO RELATED APPLICATIONS

This application claims priority to U.S. provisional application No. 63/409,154, entitled “Service Based Architecture for Non-access Stratum Evolution,” filed on Sep. 22, 2022, the disclosure of which is incorporated by reference herein in its entirety for all purposes.

### TECHNICAL FIELD

The present application relates to the field of wireless technologies and, in particular, to a service based architecture for non-access stratum evolution.

### BACKGROUND

Third Generation Partnership Project (3GPP) networks provide services that can be utilized by user equipment (UE). The user equipment may establish a connection with the networks. The UE may establish an N1 interface with an access and mobility management function (AMF) of a network to establish a connection with a network. The network may have a single AMF with which the UE may establish the N1 interface.

### BRIEF DESCRIPTION OF THE DRAWINGS

FIG. 1 illustrates an example fifth generation (5G) system architecture in accordance with some embodiments.

FIG. 2 illustrates an example system architecture having two overlay networks on a same backbone in accordance with some embodiments.

FIG. 3 illustrates an example service based evolved N1 interface (eN1) system architecture in accordance with some embodiments.

FIG. 4 illustrates an example call flow for access for architecture option 1 in accordance with some embodiments.

FIG. 5 illustrates an example system architecture in accordance with some embodiments.

FIG. 6 illustrates an example system architecture for option 2 in accordance with some embodiments.

FIG. 7 illustrates an example call flow for access for architecture option 2 in accordance with some embodiments.

FIG. 8 illustrates example services that may be presented in accordance with some embodiments.

FIG. 9 illustrates some example advantages of service based N1 interface over 5G in accordance with some embodiments.

FIG. 10 illustrates an example procedure of operating a user equipment (UE) in accordance with some embodiments.

FIG. 11 illustrates an example procedure of operating a base in accordance with some embodiments.

FIG. 12 illustrates an example procedure of operating a UE in accordance with some embodiments.

FIG. 13 illustrates an example UE in accordance with some embodiments.

FIG. 14 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

### INTRODUCTION

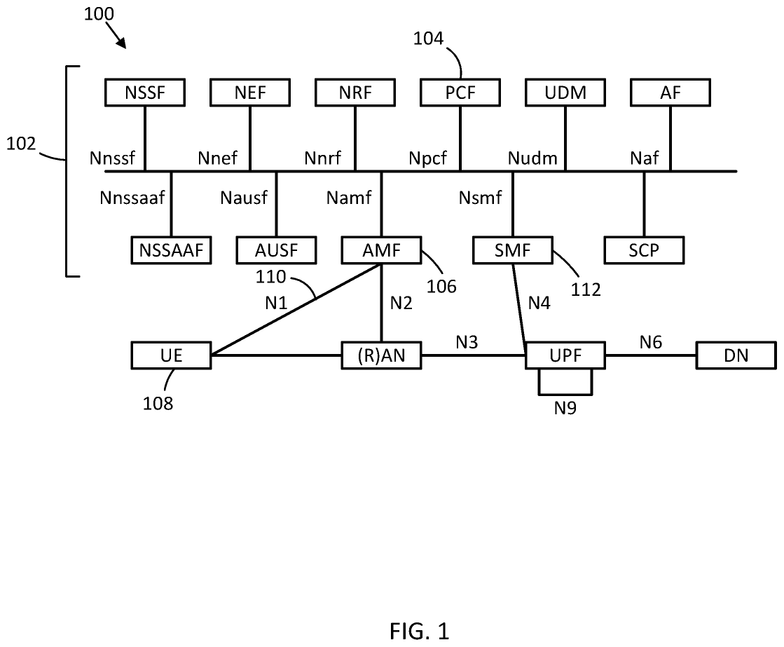

FIG. 1 illustrates an example fifth generation (5G) system architecture 100 in accordance with some embodiments. For example, the example, the system architecture 100 illustrates example components that may exists within a network. Further, the system architecture 100 illustrates example interfaces that may be established within the network.

The system architecture 100 may include a core network (CN) 102. The CN 102 may include one or more of the features of a CN as known by a person having ordinary skill in the art. For example, the CN 102 may include one or more entities that can provide services to user equipment (UE). The entities of the CN 102 may include a policy control function (PCF) 104, an access and mobility management function (AMF) 106, and a session management function (SMF) 112. The PCF 104 may provide policy rules for control plane functions and may access subscription information for policy decisions. The AMF 106 may provide registration management, connection management, and/or mobility management for the CN 102. The SMF 112 may interact with a decoupled data plane, manage protocol data unit sessions, and/or manage session context with a user plane function.

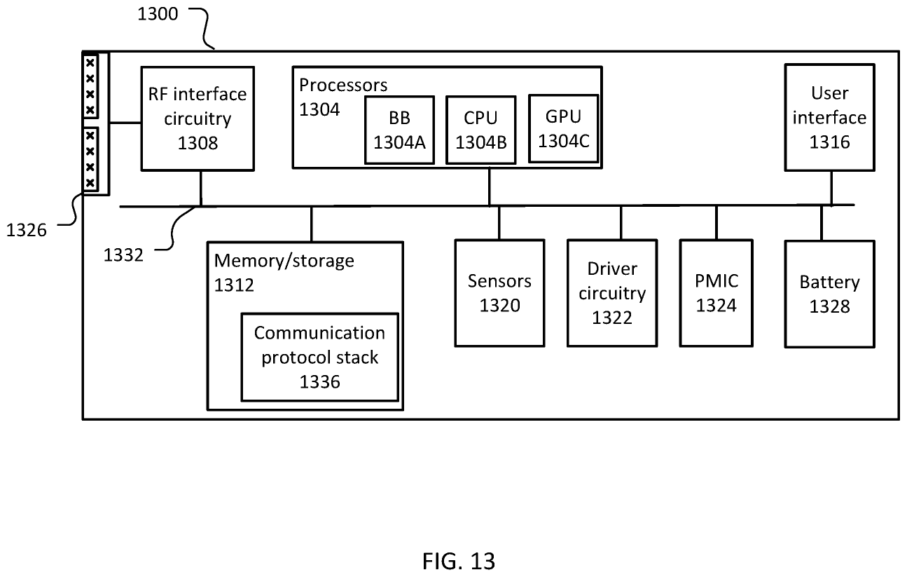

The system architecture 100 may include a UE 108. The UE 108 may include one or more of the features of the UE 1300 (FIG. 13). The UE 108 may establish a connection with the AMF 106 to utilize services of the CN 102. State of the art—N1 interface. For example, the UE 108 may establish an N1 interface 110 connection between the UE 108 and the AMF 106. The N1 interface 110 may provide for air signalling between the UE 108 and the AMF 106. User equipment (UE) 5G non-access stratum (NAS) protocol signalling with 5G CN entities. For example, the UE 108 may utilize NAS protocol signalling to communicate with the entities of the CN 102 via the N1 interface 110. 5G mobility management (5GMM) signalling terminates at AMF. For example, the mobility management signalling between the UE 108 and the AMF 106 may terminate at the AMF 106. 5G session management (5GSM) signalling carried as NAS Transport through AMF. For example, The UE 108 may transmit session management signalling via a NAS transport, which may proceed through the AMF 106 and to the SMF 112. Signalling between policy control function (PCF) and UE is carried as NAS transport. For example, signalling between the UE 108 and the PCF 104 may be carried as a NAS transport.

The N1 interface 110 presented may not be scalable to sixth generation (6G) systems. For example, the N1 interface 110 may provide for point-to-point signalling. However, point-to-point signalling may not be adequate for 6G system architectures as described further throughout this disclosure.

Motivation for N1 Evolution

Point-to-point (P2P) Signalling based N1 is not flexible for an agile evolution. New service models envisioned for 6G needs the flexibility for UE to avail new services. For example, legacy approaches that utilize the P2P signalling of the N1 interface (such as the N1 interface 110 (FIG. 1)) may not provide for the flexibility for a UE (such as the UE 108 (FIG. 1)) to avail itself of new service as envisioned for 6G systems.

Diverse capabilities of UEs. In the 6G architecture, UEs may be of a diverse nature (they could be IoT devices, smart phones, Wearable devices). Some network functionalities may be offloaded to the UE. A monolithic signalling based interface connecting UE to a Core Network node (next generation AMF) does not scale across all these variants. For example, the N1 interface that utilizes P2P signaling may not scale to the diverse variants of UEs that are envisioned to be served by 6G system architecture.

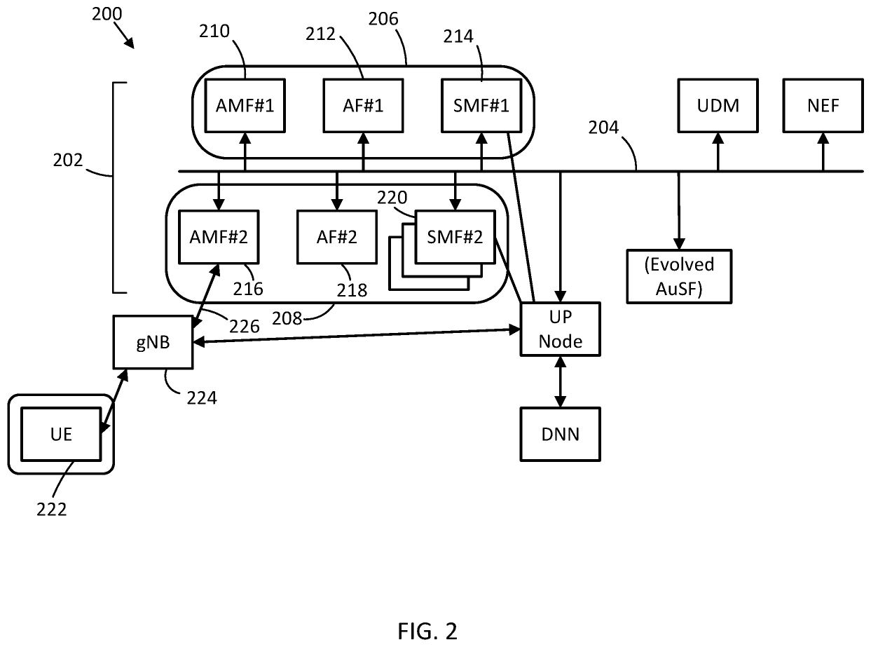

Multiple logical networks on the same core network backbone. FIG. 2 illustrates an example system architecture 200 having two overlay networks on a same backbone in accordance with some embodiments. For example, the system architecture 200 may have two networks coupled to a same CN backbone. In other embodiments, the system architecture 200 may have two or more networks coupled to the same CN backbone.

The system architecture 200 may include a CN 202. The CN 202 may include one or more of the features of a CN as known by a person having ordinary skill in the art. The CN 202 may include a CN backbone 204. The CN backbone 204 may be coupled to entities of the CN 202 and may be utilized for communication with the entities. In embodiments, the CN backbone 204 may be a hardwired connection, a wireless connection, or some combination thereof that couples the entities of the CN 202 to each other.

Two overlay networks on the same backbone. For example, the CN 202 may include a first network 206 and a second network 208 in the illustrated embodiment. Each of the first network 206 and the second network 208 may be defined to include one or more AMFs, one or more application functions (AFs), one or more SMFs, or some combination thereof. In the illustrated embodiment, the first network 206 is defined to include a first AMF 210, a first AF 212, and a first set of SMFs 214. Further, the second network 208 is defined to include a second AMF 216, a second AF 218, and a second set of SMFs 220 in the illustrated. The entities of the first network 206 and the entities of the second network 208 may both be coupled to the CN backbone 204. For example, the first AMF 210, the first AF 212, and the first set of SMFs 214 of the first network 206 may be coupled to the CN backbone 204 in the illustrated embodiment. Further, the second AMF 216, the second AF 218, and the second set of SMFs 220 of the second network 208 may be coupled to the CN backbone 204 in the illustrated embodiment.

Network #1 is a specialised network for special subscribers (with its own AMF, SMF). For example, the first network 206 may be a specialized network for special subscribers in some embodiments. Overlay networks may be instantiated dynamically (network as a service). For example, the first network 206 may be instantiated dynamically in some embodiments. Network functions may be owned and operated by the mobile network operator (MNO) or brought in by the overlay network operator. For example, the first AMF 210, the first AF 212, and/or the first set of SMFs 214 may be owned and operated by an MNO, or may be brought in by an overlay network operation. AF may provision the parameters for specialised treatment of subscribers (e.g., specific mobility management policies considering mobility pattern of the subscribers). For example, the first AF 212 may provision parameters for specialized treatment of the subscribers for the specialized network in these embodiments. UEs should have the flexibility to select an AMF to register with. For example, a UE may have flexibility to select to register with the first AMF 210 or the second AMF 216 in the illustrated embodiment.

Network #2 is a regular mobile operator network. For example, the second network 208 may be a regular mobile operator network in some embodiments.

With existing 5G Architecture, the next generation NodeBs (gNBs) should create their own N2 connections to AMF #2. For example, the system architecture 200 may include a UE 222 in the illustrated embodiment. The UE 222 may include one or more of the features of the UE 1300 (FIG. 13). The system architecture 200 may further include a base station 224, where the base station 224 may be a gNB. A connection may be established between the UE 222 and the base station 224 that allows services to be provided to the UE 222. The base station 224 may generate connections (such as N2) connections to AMFs of the CN 202 to access the services of the CN 202 that can be provided to the UE 222. In the illustrated embodiment, the base station 224 has established an N2 connection with the second AMF 216. Dynamic instantiation of new N2 links to connect to gNBs is difficult. For example, instantiation of the N2 connection 226 between the base station 224 and the second AMF 216 may be a challenge for legacy architectures. Dynamic instantiation of core networks within a fifth generation system (5GS) is difficult. For example, instantiation of the CN 202 may be a challenge for legacy architectures.

Service Based eN1: Architecture Overview

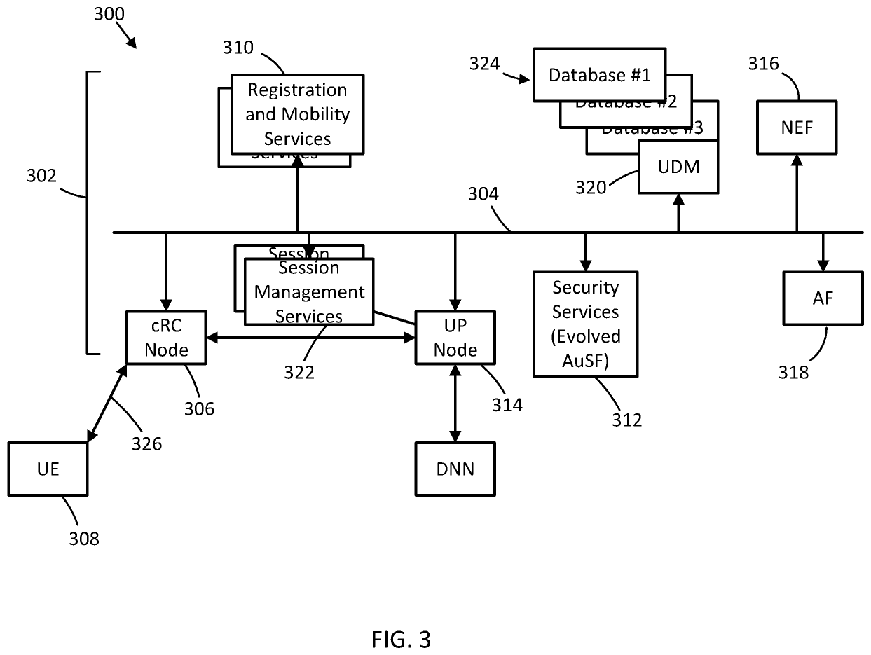

FIG. 3 illustrates an example service based evolved N1 interface (eN1) system architecture 300 in accordance with some embodiments. For example, the system architecture 300 may implement one or more eN1s that may be enhanced from legacy N1 interfaces. The system architecture 300 may be example system architecture envisioned for 6G systems in some embodiments. It should be understood that other system architectures may utilize eN1s in accordance with the description of eN1s presented herein.

The system architecture 300 may include a CN 302. The CN 302 may include one or more of the features of a CN as known by a person having ordinary skill in the art. Core Network functionality is realised as a set of services that can be accessed by the UE. For example, the CN 302 may provide a set of services that can be accessed by UEs The CN 302 may include a service bus 304 (which may also be referred to as a “CN backbone”). The service bus 304 may be coupled to entities of the CN 302 and may be utilized for communication with the entities. In embodiments, the service bus 304 may be a hardwired connection, a wireless connection, or some combination thereof that couples the entities of the CN 302 to each other.

The CN 302 may include one or more registration and mobility services entities 310. The registration and mobility services entities 310 may be coupled to the service bus 304. The registration and mobility services entities 310 may replace the AMF of legacy system architectures. Registration and Mobility Services. Manages basic UE registration and mobility operations. The registration and mobility services entities 310 may facilitate registration of UEs, such as registration with one or more entities within the CN 302. For example, the registration and mobility services entities 310 may manage basic UE registration and mobility operations.

The CN 302 may include one or more security services entities 312. The security services entities 312 may be coupled to the service bus 304. Security services. Authentication of UE and Network. The security services entities 312 may present evolved authentication server functions. For example, the security services entities 312 may provide security services for the CN 302 and/or UEs. In particular, the security services entities 312 may perform authentication operations to authenticate UEs and/or networks.

The CN 302 may include one or more session management services entities 322. The session management services entities 322 may be coupled to the service bus 304. Session management services. Services for UE data connectivity. For example, the session management services entities 322 may provide session management services for the CN 302 and/or UEs. In particular, the session management services entities 322 may provide services for UE data connectivity for UEs connecting to the network.

The CN 302 may include a unified data management (UDM) entity 320. The UDM entity 320 may be coupled to the service bus 304. Further, the UDM entity 320 may be coupled to one or more databases 324 and may manage data stored by the databases 324. The UDM entity 320 may manage the databases 324 to store UE NAS context for UEs. For example, one or more of the databases 324 may store UE NAS context for one or more UEs and the UDM entity 320 may store and/or retrieve the UE NAS context from the databases 324. Accordingly, entities of the CN 302 may access and/or cause to be stored the UE NAS context via the UDM entity 320. In some embodiments, the UDM entity 320 may manage the databases 324 to store UE access stratum (AS) context, such as embodiments when a base station is on the CN 302. The databases 324 may be accessed from any network instance in the CN 302.

The CN 302 may include a network exposure function (NEF) entity 316. The NEF entity 316 may be coupled to the service bus 304. The NEF entity 316 may provide a control plane function. The NEF entity 316 may expose one or more network capabilities to external NFs.

The CN 302 may include one or more AF entities 318. The AF entities 318 may be coupled to the service bus 304. The AF entities 318 may provide a control plane function. The AF entities 318 may comprise one or more application servers that provide support for one or more services.

The system architecture 300 may include one or more user plane (UP) nodes 314. The UP nodes 314 may be coupled to the service bus 304. The UP nodes 314 may manage the routing of UP packets between base stations and one or more external data networks.

The system architecture 300 may include a base station 306. The base station 306 may be a cRC node. New Network Function. convergedRAN-Core (cRC) Node. cRC Node is on service bus of the 6G Core Network. For example, the base station 306 may be coupled to the service bus 304. In some embodiments, the base station 306 may be placed directly onto the service bus 304. The base station 306 may have one or more functions of legacy gNBs and one or more functions of legacy AMFs in some embodiments. The base station 306 may enable service discovery and/or selection of service providers from the CN 302. Stores UE Context information. In some embodiments, the base station 306 may store UE context information for one or more UEs.

The system architecture 300 may include a UE 308. The UE 308 may include one or more of the features of the UE 1300 (FIG. 13). The UE 308 may establish a connection 326 with the base station 306, such as an eN1 interface. The base station 306 may enable the UE 308 to discover services and select an appropriate service provider from the CN 302. For example, the base station 306 may act as an entry point for the UE 308 onto the service bus 304. cRC Node enables UE to discover services and select the appropriate Service Provider. For example, the base station 306 may allow the UE 308 to discover NFs available from the CN 302 and select an appropriate NF for the UE 308 from the CN 302. For example, the UE 308 may select an appropriate NF from the registration and mobility services entities 310, the session management services entities 322, the UDM entity 320, the NEF entity 316, the AF entities 318, and/or the security services entities 312.

Architecture Option 1—Signalling Interface to cRC Node

Service based eN1: Architecture Option 1 for Service Based N1. Architecture Option 1 (Mix of radio signalling and service based architecture). For example, a first option for an architecture for an eN1 may implement a mix of radio signalling and service based architecture. UE has a signalling interface with converged RAN/Core Node. For example, a signalling interface (such as the connection 326) may be established between a UE (such as the UE 308) and a base station (such as the base station 306), where the base station may be a cRC node. The signalling interface has messages for the following procedures. For example, the signalling interface may allow for messages to be transmitted via the signalling interface for the following procedures.

System information—broadcast (cRC Node to UE). For example, the signalling interface may provide for system information to be broadcast from the base station to the UE.

Evolution from existing radio resource control (RRC) procedures including: RRC connection management, Bidirectional, procedure based; Measurement, Configuration and Reporting; Security Mode, Activation/deactivation of ciphering and integrity protection and change of algorithms. UE Capability Reporting. For example, the signalling interface may provide for messages related to the evolved RRC procedures. The evolved RRC procedures may include procedures related to RRC connection management, measurement, security mode, and/or UE capability reporting. The RRC connection management messaging may include bidirectional, procedure based messaging. The measurement messaging may include configuration and/or reporting messaging. The security mode messaging may include messaging relating to activation/deactivation of ciphering and integrity protection, and change of algorithms.

Service Discovery. UE queries available services and discovers the appropriate NF providing the service. For example, the UE may query the base station via the signalling interface for available services being provided by a CN (such as the CN 302) to which the base station is connected. The UE may receive an indication of one or more NFs that can provide services to the UE and may discover an appropriate NF providing the services for the UE based on the indication. For example, a UE requiring specialised industrial internet of things (IIoT) features can indicate the preference to discover a Registration and Mobility Management Function serving these type of UEs.

The set of services available to a UE depends on the UE state as stored in its context (either in cRC Node or in UDM)—the cRC node acts as the gate keeper for this procedure. For example, the base station may determine a set of services available to the UE based on a state of the UE stored in the UE context. The UE context may be stored in the base station or in a UDM (such as the UDM entity 320). Any UE has access to Registration and Mobility Services. For example, any UE may have access to registration and mobility services (such as the services provided by the registration and mobility services entities 310). A Registered UE has access to Registration and Mobility Services and additionally Session management and Security services. For example, a UE that has been registered with the CN may access registration and mobility services, session management services (such as the services provided by the session management services entities 322), and/or security services (such as the services presented by the security services entities 312). Registration could be normal registration or registered for emergency services. For example, a UE may register with the CN via a normal registration procedure or may register with the CN via a procedure for emergency services.

The set of services available to a UE may also depend on UE capabilities. For example, the base station may determine the set of services available to a UE based on the UE capabilities for the UE. The set of NFs available for a UE may also be controlled by the cRC Node. This may be according to UE subscription data, network loading or other local configuration. The set of NFs available for a UE may additionally also depend on UE capabilities. For example, the base station (which may be a cRC node) may determine a set of NFs available for a UE. The base station may determine the set of NF available for the UE based on UE subscription data for the UE, network loading or other local configuration related to the UE, and/or UE capabilities for the UE.

Call Flow for Access (Architecture Option 1)

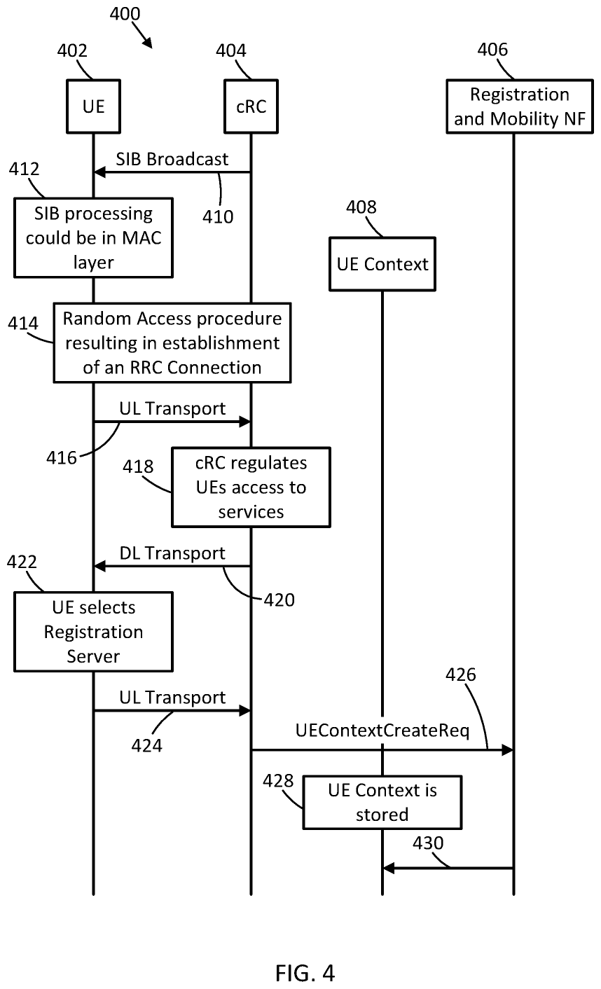

FIG. 4 illustrates an example call flow 400 for access for architecture option 1 in accordance with some embodiments. For example, the call flow 400 illustrates transmissions that may be transmitted to access an NF of a CN in accordance with architecture option 1.

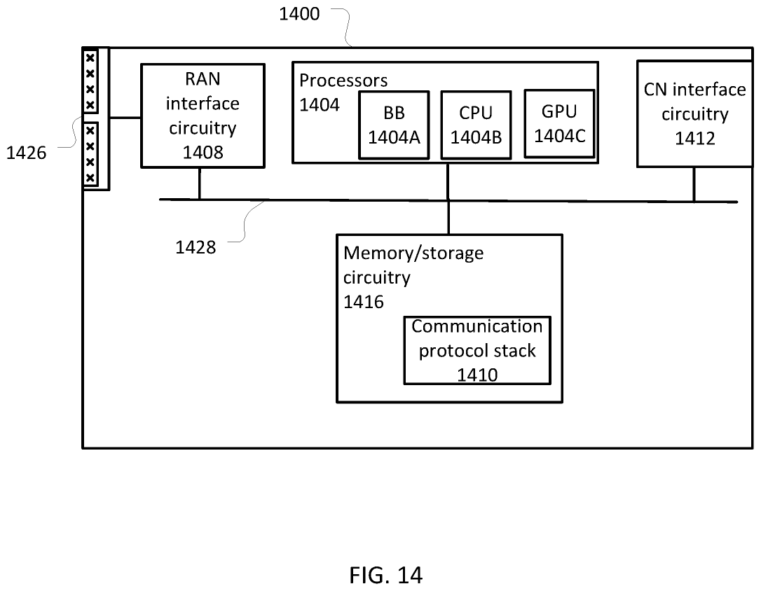

The call flow 400 illustrates entities between which transmissions may be exchanged. For example, the call flow 400 illustrates a UE 402. The UE 402 may include one or more of the features of the UE 308 (FIG. 3) and/or the UE 1300 (FIG. 13). The call flow 400 further illustrates a base station 404. The base station 404 may include one or more of the features of the base station 306 (FIG. 3) and/or the gNB 1400 (FIG. 14). The call flow 400 further illustrates a registration and mobility NF 406. The registration and mobility NF 406 may include one or more of the features of the registration and mobility services entities 310 (FIG. 3). The call flow 400 further illustrates a UE context repository 408.

As in Legacy architecture. cRC Node broadcasts system information block (SIB) messages. For example, the base station 404 may broadcast one or more SIB messages 410. SIB Contains information for Random access and establishment of RRC Connection. For example, the SIB messages 410 may include information for random access and/or establishment of RRC connection.

The UE 402 may process the SIB messages 410 broadcast by the base station 404 in 412. The UE 402 may process the SIB messages 410 in a medium access control (MAC) layer. UE performs RACH and establishes RRC Connection. For example, the UE 402 may perform a random access procedure in 414. The performance of the random access procedure may result in an establishment of an RRC connection between the UE 402 and the base station 404.

UE queries for required services and discovers the appropriate NF providing the service. For example, the UE 402 may transmit a UL transport message 416 that queries the base station 404 for required services. In some embodiments, the required services may be services defined for operation of the UE 402 and/or services to be utilized by the UE 402. The UL transport message 416 may include a registration service discovery request in the illustrated embodiment. For example, a UE requiring specialised IIoT features can indicate the preference to discover a Registration and Mobility Management Function serving these type of UEs. In particular, the UL transport message 416 may include an indication of a preference for a registration and mobility management function (such as a function provided by the registration and mobility services entities 310 (FIG. 3)) that serves UEs requiring specialized IIoT features in instances where the UE 402 is a UE that requires specialized IIoT. UE can also indicate selected public land mobile network (PLMN) from which it is discovering NFs. For example, the UL transport message 416 may also include an indication of a selected PLMN from which the UE 402 is requesting discovery of the NFs. For a periodic registration update, UE indicates the identifier of the NF instance which had registered the UE earlier. For example, the UL transport message 416 may include an indication of an identifier of an NF instance with which the UE 402 previously registered in instances of periodic registration update. This message is carried in a UL Transport message.

The base station 404 may regulate UEs access to services in 418. Regulation of access to NF. NFs can set their access to be {open to all UEs, only for registered UEs or restricted by other UE capabilities and status}. For example, NFs corresponding to the services being provided may be configured with access open to all UEs, access open only for registered UEs, or access being restricted by other UE capabilities and/or status. This information is available to the cRC node along with Discovery information. UE status is maintained in the UE Context repository. For example, UE status of the UE 402 may be maintained in the UE context repository 408. cRC may also have a copy of this status. For example, the base station 404 may store a copy of the UE status of the UE 402 in some embodiments. cRC uses this information during the service discovery from a UE. For example, the base station 404 may utilize the NF configuration information, the discovery information, and/or the UE status of the UE 402 when determining which NFs to indicate to the UE 402.

cRC Node sends the access information for available NFs matching UE's request. For example, the base station 404 may transmit a DL transport message 420 that indicates available NFs that provide the services indicated in the UL transport message 416. The base station 404 may transmit the DL transport message 420 in response to receiving the UL transport message 416. In some instances, the base station 404 may select a single NF to be utilized by the UE, thereby selecting an NF for the UE 402. In these instances, the DL transport message 420 may indicate the single NF selected by the base station 404 that is available to provide the services indicated in the UL transport message 416. In other instances, the DL transport message 420 may include a list of NFs that can provide the services indicated in the UL transport message 416 and the UE 402 may select an NF from the list of NFs to be utilized. The DL transport message 420 may provide information about available registration services in the illustrated embodiment. Response includes Internet protocol (IP) address information for the NFs. Additionally includes special information, for example, about version of service application programming interfaces (APIs) supported by NF. For example, the DL transport message 420 may include IP address information for the available NFs and/or versions of service APIs supported by the available NFs in some embodiments. The NFs indicated in the DL transport message 420 may be presented as APIs that the UE 402 may invoke.

The UE 402 may select a registration server in 422. For example, the list of available NFs indicated in the DL transport message 420 may indicate registration servers (such as the registration and mobility services entities 310) in some instances. The UE 402 may select one of the NFs from of the list of available NFs indicated in the DL transport message 420 to which the UE 402 will register. In other instances, the DL transport message 420 may indicate a single NF. In these other instances, the UE 402 may select the signal NF indicated in the DL transport message 420 to which the UE 402 will register.

Registration. UE carries out registration (UE Context creation) with the Registration and Mobility NF. For example, the UE 402 may proceed with a procedure for registering with the registration and mobility NF 406. The UE 402 may transmit a UL transport message 424 to the base station 404 that requests registration with the registration and mobility NF 406. For example, the UL transport message 424 may include a UE context create request (UEContextCreateReq) that indicates that the UE 402 is attempting to register with the registration and mobility NF 406 and/or is attempting to perform initial registration with the registration and mobility NF 406. In particular, the UL transport message 424 may include the element UEContextCreateReq (initial Registration), Registration.

The base station 404 may receive the UL transport message 424 from the UE 402. The base station 404 may transmit a UEContextCreateReq message 426 to the registration and mobility NF 406 to register the UE 402 with the registration and mobility NF 406. The UEContextCreateReq message 426 may include the UE context create request from the UL transport message 424. In particular, the UEContextCreateReq message 426 may include the UEContextCreateReq (initial Registration) from the UL transport message 424. The UEContextCreateReq (initial Registration) may register the UE 402 with the registration and mobility NF 406.

The UE context for the UE 402 may be stored in 428. For example, the registration and mobility NF 406 may transmit a UE context message 430 to the UE context repository 408, where the UE context message 430 may include the UE context for the UE 402 during the registration. The UE context repository 408 may store the UE context for the UE 402 provided in the UE context message 430.

The call flow 400 illustrates a registration procedure for the UE 402 in the illustrated embodiment. It should be understood that the UE 402 may utilize other services (such as a session management services) in other embodiments. The call flows for these other embodiments may include one or more of the features of the call flow 400, such as the discovery of the services. For example, the other call flows may include the SIB messages 410, the UL transport message 416, and/or the DL transport message 420 as part of the service discovery.

Further, the call flow 400 illustrates transmissions and operations that may be performed in accordance with some embodiments. It should be understood that one or more of the transmissions and/or one or more of the operations may be omitted, and/or one or more additional transmissions and/or one or more additional operations may be included, in other embodiments. Further, one or more of the transmissions and/or one or more of the operations may be performed concurrently in other embodiments.

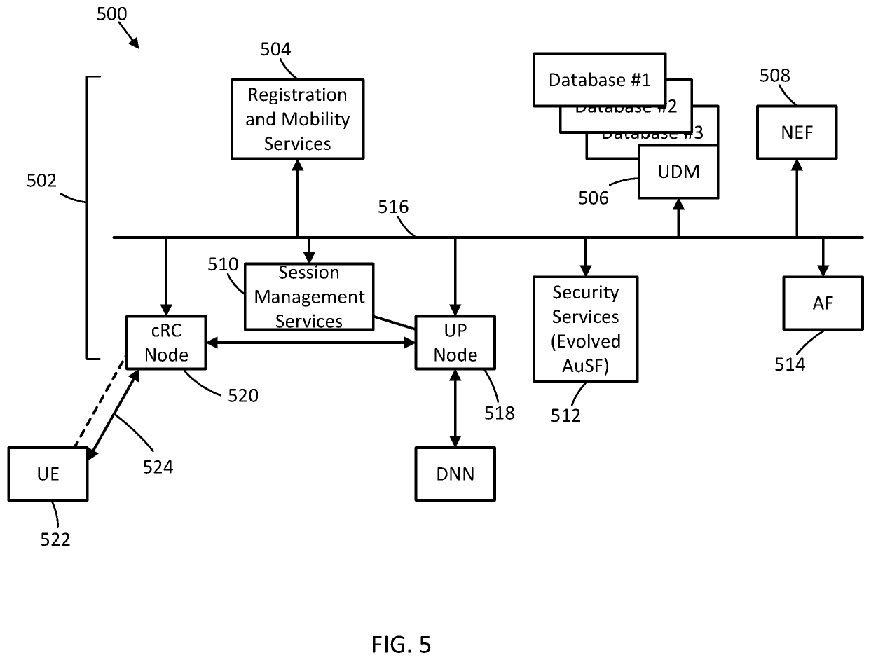

FIG. 5 illustrates an example system architecture 500 in accordance with some embodiments. For example, the system architecture 500 may illustrate a system architecture in accordance with the architecture option 1 for service based N1. The system architecture 500 may implement the call flow 400 (FIG. 4).

The system architecture 500 may include one or more of the features of the system architecture 300 (FIG. 3). For example, the system architecture 500 may include a CN 502. The CN 502 may include one or more of the features of the CN 302 (FIG. 3). The CN 502 may include a service bus 516. The service bus 516 may include one or more of the features of the service bus 304 (FIG. 3).

The CN 502 may include one or more registration and mobility services entities 504, a UDM entity 506, an NEF entity 508, one or more session management services entities 510, one or more security services entities 512, and one or more AF entities 514. The registration and mobility services entities 504 may include one or more of the features of the registration and mobility services entities 310 (FIG. 3). The UDM entity 506 may include one or more of the features of the UDM entity 320 (FIG. 3). The NEF entity 508 may include one or more of the features of the NEF entity 316 (FIG. 3). The session management services entities 510 may include one or more session management services entities 322 (FIG. 3). The security services entities 512 may include one or more of the features of the security services entities 312 (FIG. 3). The AF entities 514 may include one or more of the features of the AF entities 318 (FIG. 3).

The system architecture 500 may include a UP node 518, a base station 520, and a UE 522. The UP node 518 may include one or more of the features of the UP node 314 (FIG. 3). The base station 520 may include one or more of the features of the base station 306 (FIG. 3). The UE 522 may include one or more of the features of the UE 308 (FIG. 3).

Interface between UE and cRC Node is realised as a signalling based interface. For example, an interface 524 may be established between the UE 522 and the base station 520. The interface 524 may be a signalling based interface. The interface 524 may be bidirectional and may support transmissions in both directions between the base station 520 and the UE 522. The interface 524 may carry transmissions related to RRC connection management, service discovery, a radio transport layer, or some combination thereof. For example, the interface 524 may carry one or more transmissions of the call flow 400 (FIG. 4). In some embodiments, the interface 524 may carry the SIB messages 410 (FIG. 4), the UL transport message 416 (FIG. 4), the DL transport message 420 (FIG. 4), and/or the UL transport message 424 (FIG. 4). The interface 524 may support the UE 522 communicating with multiple different functions within a CN, which may be more flexible than the P2P of the legacy N1 interface.

Architecture Option 2: Service Based Interface with cRC Node

Service based eN1: Architecture Option 2 for service based N1. Architecture Option 2 is realised as a pure service based architecture. For example, a second option for an architecture for an eN1 may be purely service based. cRC Node broadcasts service announcements (similar to SIB content). For example, a base station (which may be a cRC node) may broadcast service announcements. The service announcements may include content similar to the information transmitted in the SIB messages 410 (FIG. 4). cRC Node broadcasts available radio resource management (RRM) Servers to be used for RRC Connection. For example, the base station may broadcast available RRM servers that can be utilized by a UE for establishing an RRC connection. RRC protocol is exercised as APIs. cRC provides APIs similar to NEF for UEs to access CN NFs. For example, the base station may indicate APIs that may be utilized by UEs to access NFs of a CN, where the APIs may be similar to NEF. Useful for architecture where UE acts as an NF and accesses CN services.

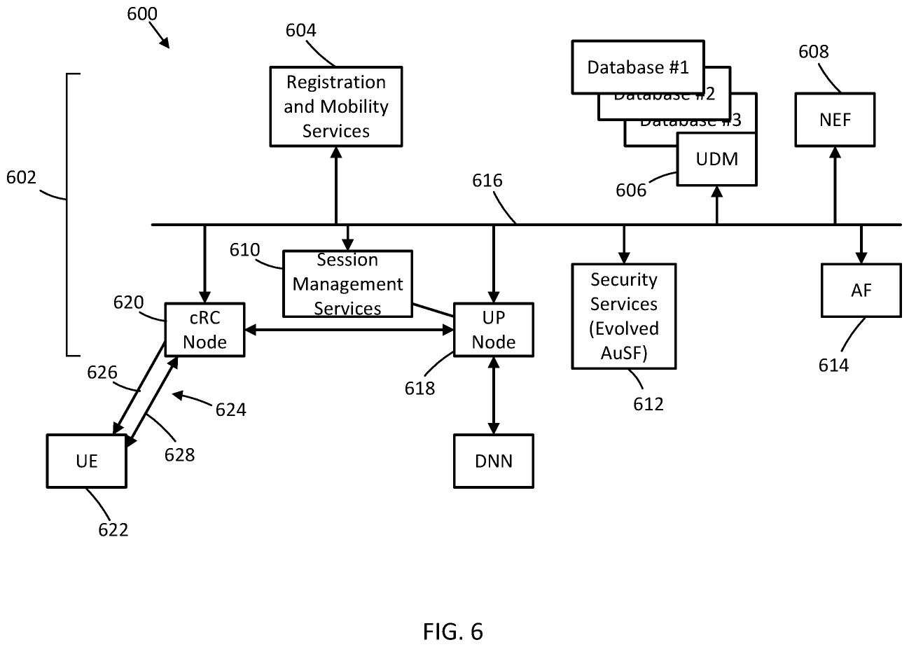

FIG. 6 illustrates an example system architecture 600 for option 2 in accordance with some embodiments. For example, the system architecture 600 may illustrate a system architecture in accordance with the architecture option 2 for service based N1.

The system architecture 600 may include one or more of the features of the system architecture 300 (FIG. 3). For example, the system architecture 600 may include a CN 602. The CN 602 may include one or more of the features of the CN 302 (FIG. 3). The CN 602 may include a service bus 616. The service bus 616 may include one or more of the features of the service bus 304 (FIG. 3).

The CN 602 may include one or more registration and mobility services entities 604, a UDM entity 606, an NEF entity 608, one or more session management services entities 610, one or more security services entities 612, and one or more AF entities 614. The registration and mobility services entities 604 may include one or more of the features of the registration and mobility services entities 310 (FIG. 3). The UDM entity 606 may include one or more of the features of the UDM entity 320 (FIG. 3). The NEF entity 608 may include one or more of the features of the NEF entity 316 (FIG. 3). The session management services entities 610 may include one or more session management services entities 322 (FIG. 3). The security services entities 612 may include one or more of the features of the security services entities 312 (FIG. 3). The AF entities 514 may include one or more of the features of the AF entities 318 (FIG. 3).

The system architecture 600 may include a UP node 618, a base station 620, and a UE 622. The UP node 618 may include one or more of the features of the UP node 314 (FIG. 3). The base station 620 may include one or more of the features of the base station 306 (FIG. 3). The UE 622 may include one or more of the features of the UE 308 (FIG. 3).

Interface between UE and cRC Node is realised as a service based interface. For example, an interface 624 may be established between the UE 622 and the base station 620. The interface 624 may be a service based interface. The interface 624 may include a first connection 626 and a second connection 628. The first connection 626 may be unidirectional and may support transmissions from the base station 620 to the UE 622, but not from the UE 622 to the base station 620. The second connection 628 may be bidirectional and may support transmissions in both directions between the base station 620 and the UE 622. The first connection 626 may carry service announcement transmissions. The second connection 628 may carry transmissions related to service discovery.

Call Flow for Access (Alternative 2)

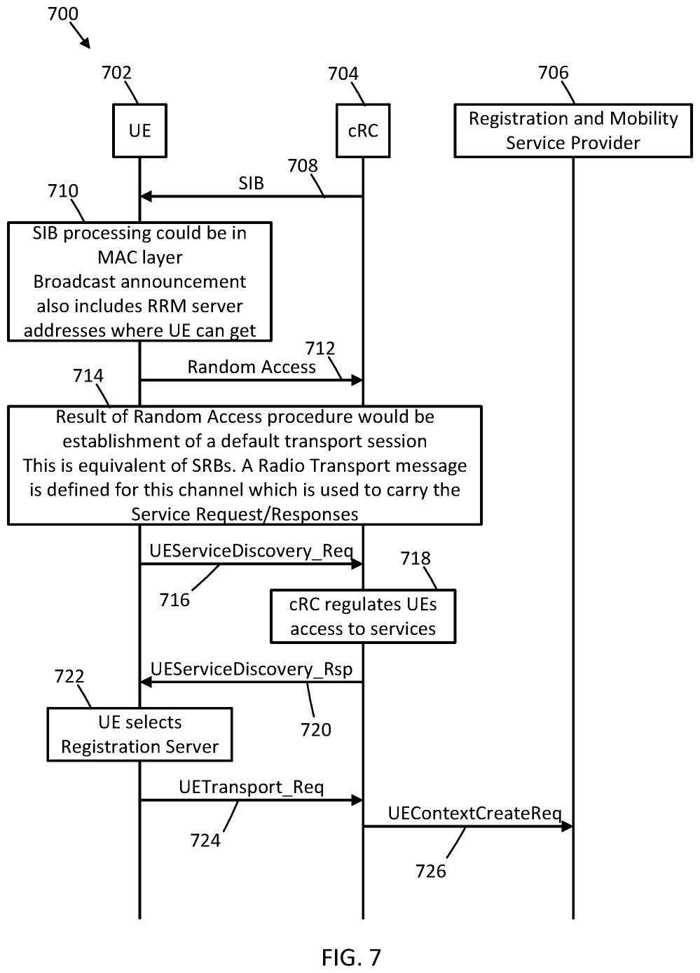

FIG. 7 illustrates an example call flow 700 for access for architecture option 2 in accordance with some embodiments. For example, the call flow 700 illustrates transmissions that may be transmitted to access an NF of a CN in accordance with architecture option 2.

The call flow 700 illustrates entities between which transmissions may be exchanged. For example, the call flow 700 illustrates a UE 702. The UE 702 may include one or more of the features of the UE 622 (FIG. 6) and/or the UE 1300 (FIG. 13). The call flow 700 further illustrates a base station 704. The base station 704 may include one or more of the features of the base station 620 (FIG. 6) and/or the gNB 1400 (FIG. 14). The call flow 700 further illustrates a registration and mobility service provider 706. The registration and mobility service provider 706 may include one or more of the features of the registration and mobility services entities 604 (FIG. 6).

Difference from Alternative 1 is the way in which UE and cRC node communicates. For example, a difference in architecture option 2 from architecture option 1 may be a way in which the UE 702 and the base station 704 (which the base station 704 may be a cRC node) communicate with each other.

The base station 704 may transmit a SIB message 708 to the UE 702. The SIB message 708 may be a broadcast announcement. The SIB message 708 may include one or more SIBs. Broadcast announcement also includes RRM server addresses where UE can get RRC connections. In some embodiments, the SIB message 708 may further include RRM server addresses where UE can get RRC connections. The base station 704 may transmit the SIB message 708 via the first connection 626 (FIG. 6) of the interface 624 (FIG. 6) in some embodiments.

The UE 702 may process the one or more SIBs received in the SIB message 708 from the base station 704 in 710. The UE 702 may process the SIBs in the MAC layer. The UE 702 my also identify one or more RRM server addresses received in the SIB message 708.

The UE 702 may transmit a random access message 712 to the base station 704. In some embodiments, the random access message 712 may be transmitted via the first connection 626 of the interface 624. The random access message 712 may initiate a random access procedure in 714. The random access procedure may result in establishment of a default transport session. The default transport session may be equivalent of signalling radio bearers (SRBs). A radio transport message may be defined for the default transport session which may be used to carry service requests and/or service responses.

The UE 702 may transmit a service discovery request message 716 to the base station 704. The service discovery request message 716 may query the base station 704 for required services. In some embodiments, the required services may be services defined for operation of the UE 702 and/or services to be utilized by the UE 702. The service discovery request message 716 may include a registration service discovery (UEServiceDiscovery_Req) request in the illustrated embodiment. For example, the service discovery request message 716 may include the element UEServiceDiscovery_Req(Registration Services). The service discovery request message 716 may include an indication of a preference for a function. Further, the service discovery request message 716 may also include an indication of a selected PLMN from which the UE 702 is requesting discovery of the NFs. The service discovery request message 716 may include an indication of an identifier of an NF instance with which the UE 702 previously registered in instances of periodic registration update. UE invokes RRC Services (ServiceDiscovery) to discover Registration NF. For example, the UE 702 may invoke RRC services to discover NFs in some embodiments.

The base station 704 may regulate UEs access to services in 718. The base station 704 may regulate access of the UE 702 to services provided by a CN to which the base station 704 is coupled. NFs corresponding to the services being provided may be configured with access open to all UEs, access open only for registered UEs, or access being restricted by other UE capabilities and/or status. The configuration of access to the NFs may be available to the base station 704 along with discovery information. The base station 704 may store UE status of the UE 702 in some embodiments. The base station 704 may utilize the NF configuration information, the discovery information, and/or the UE status of the UE 702 when determining which NFs to indicate to the UE 702.

The base station 704 may transmit a service discovery response message 720 that indicates available NFs that provide the services indicated in the service discovery request message 716. In some instances, the base station 704 may select a single NF to be utilized by the UE 702, thereby selecting an NF for the UE 402. In these instances, the service discovery response message 720 may indicate the single NF selected by the base station 704 that is available to provide the services indicated in the service discovery request message 716. In other instances, the service discovery response message 720 may include a list of NFs that can provide the services indicated in the service discovery request message 716 and the UE 702 may select an NF from the list of NFs to be utilized. The base station 704 may transmit the service discovery response message 720 in response to receiving the service discovery request message 716. cRC node also provides UETransport service through which services of other NFs are invoked (for example, Context Creation service of the NF Registration and Mobility Function). For example, the service discovery response message 720 may indicate one or more UE transport services through which services of other NFs are invoked. In the illustrated embodiment, the service discovery response message 720 may provide information about available registration services. In some embodiments, the service discovery response message 720 may include IP address information for the available NFs and/or versions of service APIs supported by the available NFs. The NFs indicated in the service discovery response message 720 may be presented as APIs that the UE 702 may invoke.

The UE 702 may select a registration server in 722. For example, the list of available NFs indicated in the service discovery response message 720 may indicate registration servers (such as the registration and mobility services entities 604) in some instances. The UE 702 may select one of the NFs from of the list of available NFs indicated in the service discovery response message 720 to which the UE 702 will register. In other instances, the service discovery response message 720 may indicate a single NF. In these other instances, the UE 702 may select the signal NF indicated in the service discovery response message 720 to which the UE 702 will register.

The UE 702 may proceed with a procedure for registering with the registration and mobility service provider 706. The UE 702 may transmit a registration request message 724 that requests registration with the registration and mobility service provider 706. For example, the registration request message 724 may include the element UETransport_Req(UEContextCreateReq (initial Registration)). The element may indicate that the UE 702 is attempting to register with the registration and mobility service provider 706 and/or is attempting to perform initial registration with the registration and mobility service provider 706.

The base station 704 may receive the registration request message 724 from the UE 702. The base station 704 may transmit a UEContextCreateReq message 726 to the registration and mobility service provider 706 to register the UE 702 with the registration and mobility service provider 706. The UEContextCreateReq message 726 may include the UE context create request from the registration request message 724. In particular, the UEContextCreateReq message 726 may include the UEContextCreateReq (initial Registration) from the registration request message 724. The UEContextCreateReq (initial Registration) may register the UE 702 with the registration and mobility service provider 706.

The call flow 700 illustrates a registration procedure for the UE 702 in the illustrated embodiment. It should be understood that the UE 702 may utilize other services (such as a session management services) in other embodiments. The call flows for these other embodiments may include one or more of the features of the call flow 700, such as the discovery of the services. For example, the other call flows may include the SIB message 708, the random access message 712, the service discovery request message 716, and/or the service discovery response message 720 as part of the service discovery.

Further, the call flow 700 illustrates transmissions and operations that may be performed in accordance with some embodiments. It should be understood that one or more of the transmissions and/or one or more of the operations may be omitted, and/or one or more additional transmissions and/or one or more additional operations may be included, in other embodiments. Further, one or more of the transmissions and/or one or more of the operations may be performed concurrently in other embodiments.

### Example Services

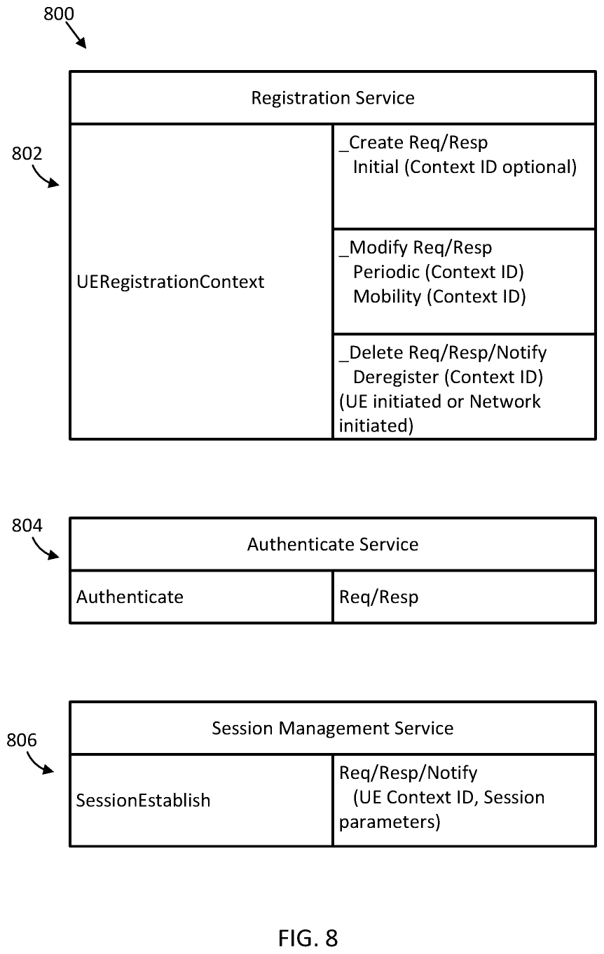

FIG. 8 illustrates example services 800 that may be presented in accordance with some embodiments. For example, the services 800 may include services that can be provided by the architecture option 1 and/or the architecture option 2 described throughout this application. In particular, a UE in architecture option 1 and/or architecture option 2 may request any of the services 800 and a base station may respond with NFs that provide any of the services in embodiments. The eN1 interface of the architecture option 1 and/or the architecture option 2 may facilitate the services.

The services 800 may include registration services 802. The registration services 802 may be indicated by the element UERegistrationContext. The registration services 802 may include create request and create response messages. The create request and create response messages may be utilized for registration and/or initial registration of a UE. A context identifier (ID) may be optional for the create request and create response messages.

The registration services 802 may further include modify request and modify response messages. The modify request and modify response messages may be utilized for modification of a registration of a UE. The modifications may be either periodic modifications or mobility modifications. A context ID may be included for the modify request and modify response messages.

The registration services 802 may further include delete request, delete response, and delete notify messages. The delete request, delete response, and delete notify messages may be utilized for deleting a registration of a UE. The deletion may include a deregister request that includes a context ID corresponding to the UE for which registration is to be deleted. The deletion may be either UE initiated or network (such as via a base station) initiated.

The services 800 may include authentication services 804. The authentication services 804 may be indicated by the element Authenticate. The authentication services 804 may include authenticate request and authenticate response messages. The authenticate request and authenticate response messages may be utilized for authenticating a UE, a base station, and/or a network.

The services 800 may include session management services 806. The session management services 806 may be indicated by the element SessionEstablish. The session management services 806 may include session establish request, session establish response, and session establish notify messages. The session establish request, session establish response, and session establish notify messages may be utilized for establishing a session. The session establish request, session establish response, and/or session establish notify messages may include a UE context ID and/or session parameters.

Advantages of Service Based N1 over 5G

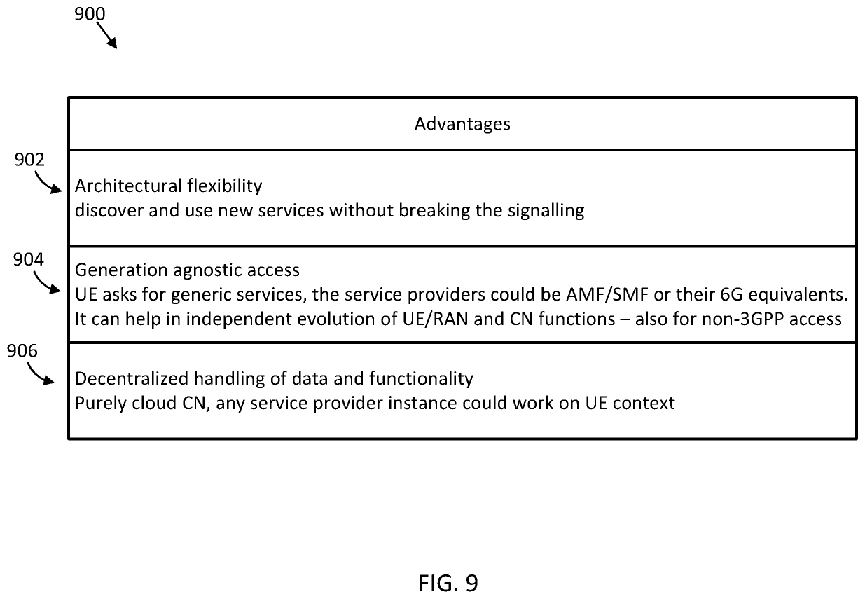

FIG. 9 illustrates some example advantages 900 of service based N1 interface over 5G in accordance with some embodiments. For example, the advantages 900 may present advantages of the architecture option 1 and/or the architecture option 2 described throughout this disclosure. For example, the advantage 900 may be presented by the eN1 interface of the architecture option 1 and/or the architecture option 2.

The advantages 900 may include architectural flexibility 902. For example, a UE may be able to discover and use new services without breaking the signalling.

The advantages 900 may include generation agnostic access 904. For example, the UE may ask for generic services. The service providers could be AMF/SMF, their 6G equivalents, or other equivalent entities. The generation agnostic access may help in independent evolution of UE/radio access network (RAN) and/or CN functions, including for non-third generation partnership project (3GPP) access.

The advantages 900 may include decentralized handling of data and functionality 906. For example, any service provider instance could work on UE context. Further, purely cloud CN may be implemented.

In some examples, a convergedRANCore Node (cRC): Is a network function in the service bus of next generation core network; Terminates the air interface with the UE; Has service based interfaces to the NFs; Terminates the direct connection with the UE (includes RRC and parts of Mobility Management); Performs gating of UE requests for Core Network services (for registration/mobility, session management, security); Stores/manages UE contexts.

The interface UE—cRC: Realised as a signalling interface; Broadcasts system information: includes NF access information for Registration and Mobility management, system information is processed in the RRC or MAC layer in the UE; Transport layer for invoking service based interfaces towards the NFs for registration and mobility management, session management and security.

The interface UE—cRC: Realised as a service based interface; Broadcasts service announcement containing NF information for Radio Resource control, registration and mobility management, session management and security, Service announcements are processed in the RRC or MAC layer in the UE.

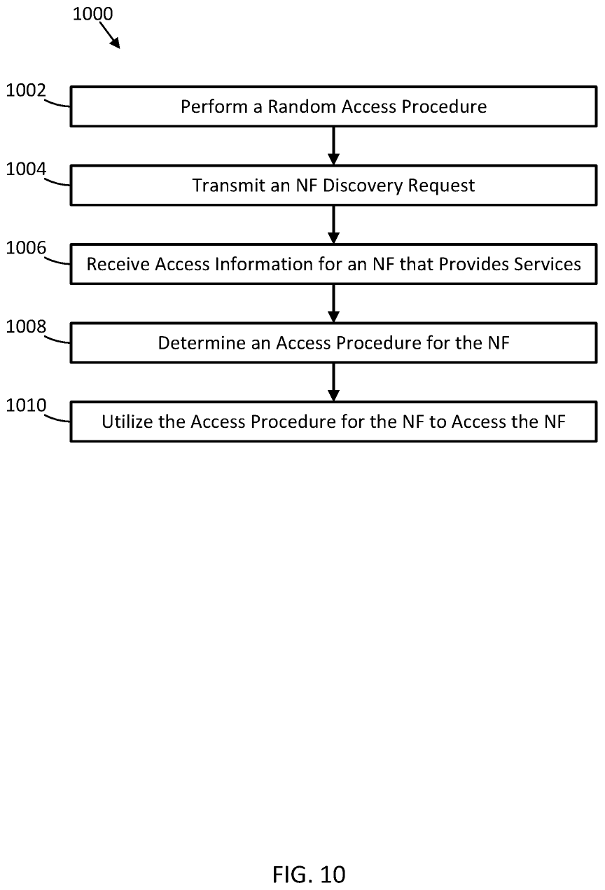

FIG. 10 illustrates an example procedure 1000 of operating a UE in accordance with some embodiments. For example, the procedure 1000 may be performed by the UE 308 (FIG. 3), the UE 402 (FIG. 4), the UE 522 (FIG. 5), the UE 622 (FIG. 6), the UE 702 (FIG. 7), and/or the UE 1300 (FIG. 13). The procedure 1000 may result in the UE accessing an NF that provides services for the UE.

The procedure 1000 may include performing a random access procedure in 1002. For example, the procedure 1000 may perform a random access procedure to establish a transport session. In some embodiments, the random access procedure may include operations performed by the UE and/or the base station, and/or transmissions exchanged between the UE and the base station. It should be understood that the UE performing the random access procedure refers to the UE performing the operations to be performed by the UE and/or UE transmitting the transmissions to be transmitted by the UE as part of the random access procedure. In some embodiments, 1002 may be omitted.

The procedure 1000 may include transmitting an NF discovery request in 1004. For example, the UE may transmit an NF discovery request to discover NFs that can provide services defined for operation of the UE. In some embodiments, the NF discovery request may indicate characteristics of the UE. Further, the NF discovery request may indicate a selected PLMN associated with the UE in some embodiments. In some embodiments, the NF discovery request may indicate an identify of an NF instance which had previously registered the UE. In some embodiments, the NF discovery request may be carried in a UL transport message. In some embodiments where 1002 has been performed, the NF discovery request may be carried in a radio transport message associated with the transport session established in 1002.

The procedure 1000 may include receiving access information for an NF that provides services in 1006. For example, the UE may receive, from the base station, access information for an NF that can provide the services defined for operation of the UE. In some embodiments, the NFs that can provide the services defined for operation of the UE are selected based on the characteristics of the UE. Further, the NFs that can provide the services defined for operation of the UE are selected based on the selected PLMN associated with the UE in some embodiments.

The procedure 1000 may include determining an access procedure for the NF in 1008. For example, the UE may determine, based on the access information, an access procedure for the NF to be utilized by the UE.

The procedure 1000 may include utilizing the access procedure for the NF to access the NF in 1010. For example, the UE may utilize the access procedure for the NF to access the NF.

FIG. 10 may be read to imply an order of operations for the procedure 1000. However, it should be understood that the operations may be performed in different orders in other embodiments. Additionally, one or more operations of the procedure 1000 may be omitted and/or one or more additional operations may be included in the procedure 1000 in other embodiments. Further, it should be understood that one or more of the operations of the procedure 1000 may be performed concurrently in some embodiments.

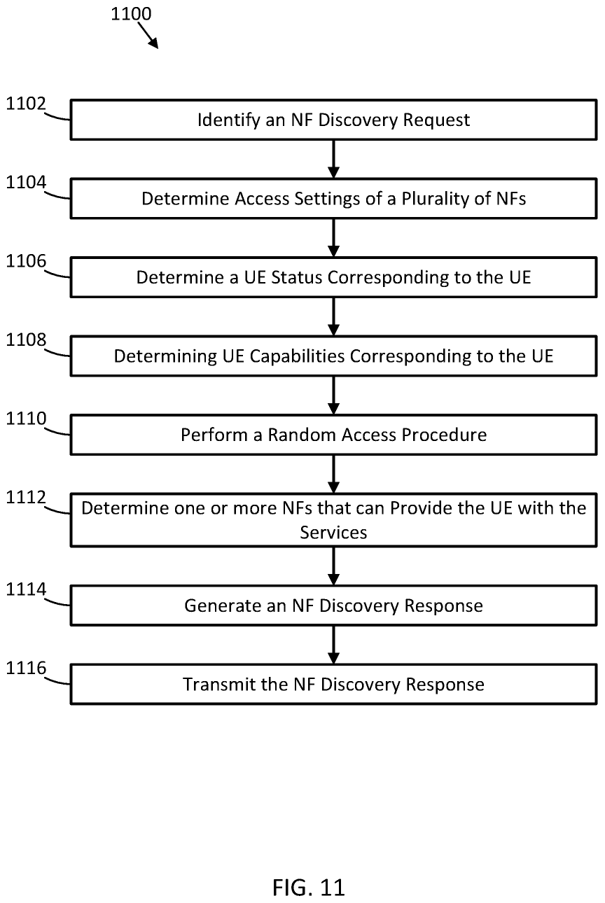

FIG. 11 illustrates an example procedure 1100 of operating a base in accordance with some embodiments. For example, the procedure 1100 may be performed by the base station 306 (FIG. 3), the base station 404 (FIG. 4), the base station 520 (FIG. 5), the base station 620 (FIG. 6), the base station 704 (FIG. 7), and/or the gNB 1400 (FIG. 14). In some embodiments, the base station may comprise a cRC node. The procedure 1100 may result in the base station providing information regarding NFs to a UE.

The procedure 1100 may include identifying an NF discovery request in 1102. For example, the base station may identify an NF discovery request received from a UE. The NF discovery request may indicate services for the UE.

The procedure 1100 may include determining access settings of a plurality of NFs in 1104. For example, the base station may determine access settings of a plurality of NFs coupled to the base station. In some embodiments, 1104 may be omitted.

The procedure 1100 may include determining a UE status corresponding to the UE in 1106. For example, the base station may determine a UE status corresponding to the UE. In some embodiments, 1106 may be omitted.

The procedure 1100 may include determining UE capabilities corresponding to the UE in 1108. For example, the UE may determine UE capabilities corresponding to the UE. In some embodiments, 1108 may be omitted.

The procedure 1100 may include performing a random access procedure in 1110. For example, the base station may perform a random access procedure to establish a transport session between the base station and the UE. In some embodiments, the random access procedure may include operations performed by the UE and/or the base station, and/or transmissions exchanged between the UE and the base station. It should be understood that the base station performing the random access procedure refers to the base station performing the operations to be performed by the base station and/or base station transmitting the transmissions to be transmitted by the base station as part of the random access procedure. In some embodiments, 1110 may be omitted.

The procedure 1100 may include determining or more NFs that can Prove the UE with the services in 1112. For example, the base station may determine, based on the services indicated in the NF discovery request, one or more NFs that can provide the UE with the services. In some embodiments, the one or more NFs that can provide the UE with the services are further determined based on the access settings of the plurality of NFs. Further, the one or more NFs that can provide the UE with the services are further determined based on the UE status in some embodiments. In some embodiments, the one or more NFs that can provide the UE with the services are further determined based on the UE capabilities.

The procedure 1100 may include generating an NF discovery response in 1114. For example, the base station may generate an NF discovery response that indicates the one or more NFs. In some embodiments, the NF discovery response may comprise one or more IP addresses corresponding to the one or more NFs. Further, the NF discovery response may comprise one or more indications of versions of service APIs supported by the one or more NFs in some embodiments.

The procedure 1100 may include transmitting the NF discovery response in 1116. For example, the base station may transmit the NF discovery response to the UE. In some embodiments, the NF discovery response may be carried in a DL transport message. In some embodiments where 1110 is performed, the NF discovery response may be carried in a radio transport message associated with the transport session established in 1110.

FIG. 11 may be read to imply an order of operations for the procedure 1100. However, it should be understood that the operations may be performed in different orders in other embodiments. Additionally, one or more operations of the procedure 1100 may be omitted and/or one or more additional operations may be included in the procedure 1100 in other embodiments. Further, it should be understood that one or more of the operations of the procedure 1100 may be performed concurrently in some embodiments.

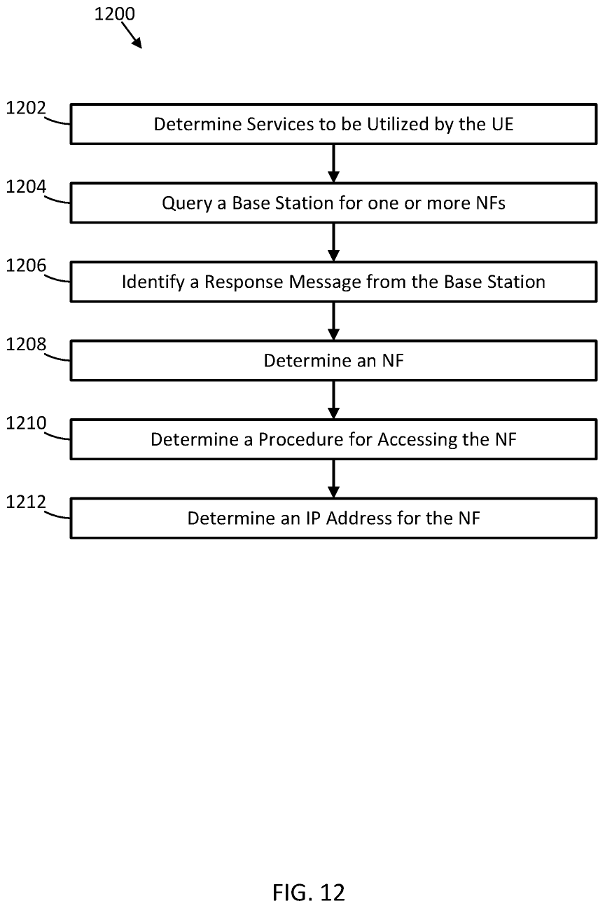

FIG. 12 illustrates an example procedure 1200 of operating a UE in accordance with some embodiments. For example, the procedure 1200 may be performed by the UE 308 (FIG. 3), the UE 402 (FIG. 4), the UE 522 (FIG. 5), the UE 622 (FIG. 6), the UE 702 (FIG. 7), and/or the UE 1300 (FIG. 13). The procedure 1200 may result in the UE determining an NF with which to register.

The procedure 1200 may include determining services to be utilized by the UE in 1202. For example, the UE may determine services to be utilized by the UE.

The procedure 1200 may include querying a base station for one or more NFs in 1204. For example, the UE may query a base station for one or more NFs that can provide the services to the UE. In some embodiments, querying the base station may include transmitting a UL transport message that indicates the services to the base station. In some embodiments, querying the base station may include performing a random access procedure to establish a transport session and transmitting a radio transport message associated with the transport session to the base station. The radio transport message may indicate the services. In some embodiments, the random access procedure may include operations performed by the UE and/or the base station, and/or transmissions exchanged between the UE and the base station. It should be understood that the UE performing the random access procedure refers to the UE performing the operations to be performed by the UE and/or UE transmitting the transmissions to be transmitted by the UE as part of the random access procedure.

The procedure 1200 may include identifying a response message from the base station in 1206. For example, the UE may identify a response message from the base station that indicates the one or more NFs that can provide the services to the UE.

The procedure 1200 may include determining an NF in 1208. For example, the UE may determine an NF of the one or more NFs that can provide the services to the UE with which to register.

The procedure 1200 may include determining a procedure for accessing the NF in 1210. For example, the UE may determine a procedure for accessing the NF based on access information for the one or more NFs indicated in the response message. In some embodiments, 1210 may be omitted.

The procedure 1200 may include determining an IP address for the NF in 1212. For example, the UE may determine an IP address for the NF based on IP address information for the one or more NFs indicated in the response message. In some embodiments, 1212 may be omitted.

FIG. 12 may be read to imply an order of operations for the procedure 1200. However, it should be understood that the operations may be performed in different orders in other embodiments. Additionally, one or more operations of the procedure 1200 may be omitted and/or one or more additional operations may be included in the procedure 1200 in other embodiments. Further, it should be understood that one or more of the operations of the procedure 1200 may be performed concurrently in some embodiments.

FIG. 13 illustrates an example UE 1300 in accordance with some embodiments. The UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1300 may be a RedCap UE or NR-Light UE.

The UE 1300 may include processors 1304, RF interface circuitry 1308, memory/storage 1312, user interface 1316, sensors 1320, driver circuitry 1322, power management integrated circuit (PMIC) 1324, antenna structure 1326, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangement of the components shown may occur in other implementations.

The components of the UE 1300 may be coupled with various other components over one or more interconnects 1332, which may represent any type of interface, input/output, bus (local, system, or expansion), transmission line, trace, optical connection, etc. that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1312 to cause the UE 1300 to perform operations as described herein.

In some embodiments, the baseband processor circuitry 1304A may access a communication protocol stack 1336 in the memory/storage 1312 to communicate over a 3GPP compatible network. In general, the baseband processor circuitry 1304A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1312 may include one or more non-transitory, computer-readable media that includes instructions (for example, communication protocol stack 1336) that may be executed by one or more of the processors 1304 to cause the UE 1300 to perform various operations described herein. The memory/storage 1312 include any type of volatile or non-volatile memory that may be distributed throughout the UE 1300. In some embodiments, some of the memory/storage 1312 may be located on the processors 1304 themselves (for example, L1 and L2 cache), while other memory/storage 1312 is external to the processors 1304 but accessible thereto via a memory interface. The memory/storage 1312 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 1308 may include transceiver circuitry and radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1326 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1326.

In various embodiments, the RF interface circuitry 1308 may be configured to transmit/receive signals in a manner compatible with NR access technologies.

The antenna 1326 may include antenna elements to convert electrical signals into radio waves to travel through the air and to convert received radio waves into electrical signals. The antenna elements may be arranged into one or more antenna panels. The antenna 1326 may have antenna panels that are omnidirectional, directional, or a combination thereof to enable beamforming and multiple input, multiple output communications. The antenna 1326 may include microstrip antennas, printed antennas fabricated on the surface of one or more printed circuit boards, patch antennas, phased array antennas, etc. The antenna 1326 may have one or more panels designed for specific frequency bands including bands in FR1 or FR2.

The user interface circuitry 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1300.

The sensors 1320 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within, or connected to, the UE 1300. For example, driver circuitry 1322 may include a display driver to control and allow access to a display device, a touchscreen driver to control and allow access to a touchscreen interface, sensor drivers to obtain sensor readings of sensor circuitry 1320 and control and allow access to sensor circuitry 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

In some embodiments, the PMIC 1324 may control, or otherwise be part of, various power saving mechanisms of the UE 1300. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1300 may power down for brief intervals of time and thus save power. If there is no data traffic activity for an extended period of time, then the UE 1300 may transition off to an RRC_Idle state, where it disconnects from the network and does not perform operations such as channel quality feedback, handover, etc. The UE 1300 goes into a very low power state and it performs paging where again it periodically wakes up to listen to the network and then powers down again. The UE 1300 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1328 may power the UE 1300, although in some examples the UE 1300 may be mounted deployed in a fixed location, and may have a power supply coupled to an electrical grid. The battery 1328 may be a lithium ion battery, a metal-air battery, such as a zinc-air battery, an aluminum-air battery, a lithium-air battery, and the like. In some implementations, such as in vehicle-based applications, the battery 1328 may be a typical lead-acid automotive battery.

FIG. 14 illustrates an example gNB 1400 in accordance with some embodiments. The gNB 1400 may include processors 1404, RF interface circuitry 1408, core network (CN) interface circuitry 1412, memory/storage circuitry 1416, and antenna structure 1426.

The components of the gNB 1400 may be coupled with various other components over one or more interconnects 1428.

The processors 1404, RF interface circuitry 1408, memory/storage circuitry 1416 (including communication protocol stack 1410), antenna structure 1426, and interconnects 1428 may be similar to like-named elements shown and described with respect to FIG. 13.

The CN interface circuitry 1412 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1400 via a fiber optic or wireless backhaul. The CN interface circuitry 1412 may include one or more dedicated processors or FPGAs to communicate using one or more of the aforementioned protocols. In some implementations, the CN interface circuitry 1412 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method of operating a user equipment (UE), comprising transmitting a network function (NF) discovery request to discover NFs that can provide services defined for operation of the UE, receiving, from a base station, access information for an NF that can provide the services defined for operation of the UE, determining, based on the access information, an access procedure for the NF to be utilized by the UE, and utilizing the access procedure for the NF to access the NF.

Example 2 may include the method of example 1, wherein the NF discovery request indicates characteristics of the UE, and wherein the NFs that can provide the services defined for operation of the UE are selected based on the characteristics of the UE.

Example 3 may include the method of example 1, wherein the NF discovery request indicates a selected public land mobile network (PLMN) associated with the UE, and wherein the NFs that can provide the services defined for operation of the UE are selected based on the selected PLMN associated with the UE.

Example 4 may include the method of example 1, wherein the NF discovery request indicates an identifier of a NF instance which had previously registered the UE.

Example 5 may include the method of example 1, wherein the NF discovery

request is carried in an uplink (UL) transport message.

Example 6 may include the method of example 1, further comprising performing a random access procedure to establish a transport session, wherein the NF discovery request is carried in a radio transport message associated with the transport session.

Example 7 may include a method of operating a base station, comprising identifying a network function (NF) discovery request received from a user equipment (UE), the NF discovery request indicating services for the UE, determining, based on the services indicated in the NF discovery request, one or more NFs that can provide the UE with the services, generating an NF discovery response that indicates the one or more NFs, and transmitting the NF discovery response to the UE.

Example 8 may include the method of example 7, wherein the NF discovery response comprises one or more Internet protocol (IP) addresses corresponding to the one or more NFs.

Example 9 may include the method of example 7, wherein the NF discovery response comprises one or more indications of versions of service application programming interfaces (APIs) supported by the one or more NFs.

Example 10 may include the method of example 7, further comprising determining access settings of a plurality of NFs coupled to the base station, wherein the one or more NFs that can provide the UE with the services are further determined based on the access settings of the plurality of NFs.

Example 11 may include the method of example 7, further comprising determining a UE status corresponding to the UE, wherein the one or more NFs that can provide the UE with the services are further determined based on the UE status.

Example 12 may include the method of example 7, further comprising determining UE capabilities corresponding to the UE, wherein the one or more NFs that can provide the UE with the services are further determined based on the UE capabilities.

Example 13 may include the method of example 7, wherein the NF discovery response is carried in a downlink (DL) transport message.

Example 14 may include the method of example 7, further comprising performing a random access procedure to establish a transport session between the base station and the UE, wherein the NF discovery response is carried in a radio transport message associated with the transport session.

Example 15 may include the method of example 7, wherein the base station comprises a converged radio access network core (cRC) node.

Example 16 may include a method of operating a user equipment (UE), comprising determining services to be utilized by the UE, querying a base station for one or more NFs that can provide the services to the UE, identifying a response message from the base station that indicates the one or more NFs that can provide the services to the UE, and determining an NF of the one or more NFs that can provide the services to the UE with which to register.

Example 17 may include the method of example 16, further comprising determining a procedure for accessing the NF based on access information for the one or more NFs indicated in the response message.

Example 18 may include the method of example 16, further comprising determining an Internet protocol (IP) address for the NF based on IP address information for the one or more NFs indicated in the response message.

Example 19 may include the method of example 16, wherein querying the base station comprises transmitting an uplink (UL) transport message that indicates the services to the base station.

Example 20 may include the method of example 16, wherein querying the base station comprises performing a random access procedure to establish a transport session, and transmitting a radio transport message associated with the transport session to the base station, where the radio transport message indicates the services.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-20, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed by one or more processors, cause a user equipment (UE) to:
transmit a network function (NF) discovery request to discover NFs that can provide services defined for operation of the UE;
receive, from a base station, access information for an NF that can provide the services defined for operation of the UE;
determine, based on the access information, an access procedure for the NF to be utilized by the UE; and
utilize the access procedure for the NF to access the NF.

2. The one or more non-transitory, computer-readable media of claim 1, wherein the NF discovery request indicates characteristics of the UE, and wherein the NFs that can provide the services defined for operation of the UE are selected based on the characteristics of the UE.

3. The one or more non-transitory, computer-readable media of claim 1, wherein the NF discovery request indicates a selected public land mobile network (PLMN) associated with the UE, and wherein the NFs that can provide the services defined for operation of the UE are selected based on the selected PLMN associated with the UE.

4. The one or more non-transitory, computer-readable media of claim 1, wherein the NF discovery request indicates an identifier of a NF instance which had previously registered the UE.

5. The one or more non-transitory, computer-readable media of claim 1, wherein the NF discovery request is carried in an uplink (UL) transport message.

6. The one or more non-transitory, computer-readable media of claim 1, wherein the instructions, when executed by the one or more processors, further cause the UE to:
perform a random access procedure to establish a transport session, wherein the NF discovery request is carried in a radio transport message associated with the transport session.

7. A base station, comprising:
memory to store information associated with a plurality of NFs coupled to the base station; and
one or more processors coupled to the memory, the one or more processors to:
identify a network function (NF) discovery request received from a user equipment (UE), the NF discovery request indicating services for the UE;
determine, based on the services indicated in the NF discovery request, one or more NFs that can provide the UE with the services;
generate an NF discovery response that indicates the one or more NFs; and
transmit the NF discovery response to the UE.

8. The base station of claim 7, wherein the NF discovery response comprises one or more Internet protocol (IP) addresses corresponding to the one or more NFs.

9. The base station of claim 7, wherein the NF discovery response comprises one or more indications of versions of service application programming interfaces (APIs) supported by the one or more NFs.

10. The base station of claim 7, wherein the one or more processors are further to:
determine access settings of the plurality of NFs coupled to the base station, wherein the one or more NFs that can provide the UE with the services are further determined based on the access settings of the plurality of NFs.

11. The base station of claim 7, wherein the one or more processors are further to:
determine a UE status corresponding to the UE, wherein the one or more NFs that can provide the UE with the services are further determined based on the UE status.

12. The base station of claim 7, wherein the one or more processors are further to:
determine UE capabilities corresponding to the UE, wherein the one or more NFs that can provide the UE with the services are further determined based on the UE capabilities.

13. The base station of claim 7, wherein the NF discovery response is carried in a downlink (DL) transport message.

14. The base station of claim 7, wherein the one or more processors are further to:
perform a random access procedure to establish a transport session between the base station and the UE, wherein the NF discovery response is carried in a radio transport message associated with the transport session.

15. The base station of claim 7, wherein the base station comprises a converged radio access network core (cRC) node.

16. A method of operating a user equipment (UE), comprising:
determining services to be utilized by the UE;
querying a base station for one or more network functions (NFs) that can provide the services to the UE;
identifying a response message from the base station that indicates the one or more NFs that can provide the services to the UE; and
determining an NF of the one or more NFs that can provide the services to the UE with which to register.

17. The method of claim 16, further comprising:
determining a procedure for accessing the NF based on access information for the one or more NFs indicated in the response message.

18. The method of claim 16, further comprising:
determining an Internet protocol (IP) address for the NF based on IP address information for the one or more NFs indicated in the response message.

19. The method of claim 16, wherein querying the base station comprises transmitting an uplink (UL) transport message that indicates the services to the base station.

20. The method of claim 16, wherein querying the base station comprises:
performing a random access procedure to establish a transport session; and
transmitting a radio transport message associated with the transport session to the base station, where the radio transport message indicates the services.
